(19) United States
(12) Patent Application Publication
(10) Pub. No.: US 2024/0070574 A1
(43) Pub. Date: Feb. 29, 2024

(54) OPTIMAL SELECTION OF A SERVICE REQUEST RESPONSE TEAM

(71) Applicant: International Business Machines Corporation, Armonk, NY (US)

(72) Inventors: Soumitra Sarkar, Cary, NC (US); Yu Deng, Yorktown Heights, NY (US); John Alan Bivens, Ossining, NY (US); Muhammad Jawad Paracha, Karachi (PK); Ruchi Mahindru, Elmsford, NY (US)

(73) Assignee: International Business Machines Corporation, Armonk, NY (US)

(21) Appl. No.: 17/971,381

(22) Filed: Oct. 21, 2022

(30) Foreign Application Priority Data
Aug. 25, 2022 (PK) 556/2022

(51) Int. Cl. G06Q 10/06; G06Q 10/00

(52) U.S. Cl. CPC G06Q 10/063112; G06Q 10/20

(57) ABSTRACT

An embodiment includes creating an action item record corresponding to an action item of an action plan record that is responsive to a service request. The action item record comprises a service requirement of the action item. The embodiment executes a querying process that searches vendor records for candidate vendors associated with the service requirement and returns a set of candidate vendors. The embodiment updates the action item record with the set of candidate vendors and determines an optimal vendor team based at least in part on reputation data and cost data associated with each of the candidate vendors. The embodiment updates the action plan record to include the optimal vendor team, which triggers creation of a vendor team dispatch request.

### BACKGROUND

The present invention relates generally to a method, system, and computer program product for project planning. More particularly, the present invention relates to a method, system, and computer program product for optimal selection of a service request response team.

Recent years have seen significant increases in the sophistication of computing resources utilized by enterprises of various types and sizes. This growth has been driven in large part by the improved accessibility of such systems as various distributed and cloud-based service models have emerged, such as Software as a Service (SaaS), Platform as a Service (PaaS), and Infrastructure as a Service (IaaS) computing models. This has paved the way to dramatic increases in the adoption of new technologies, such as artificial intelligence (AI), Internet of Things (IoT), Augmented Reality (AR)/Virtual Reality (VR), blockchain, and data mining technologies. Many companies have also expanded their use of digital platforms to improve customer communications, assist with industry compliance issues, and a myriad of other applications. This shift towards using more sophisticated computing systems has led to a dramatic increase in demand for technical support services. In some cases, companies have an internal information technology (IT) department and/or a help desk that coordinates technical support services internally for the company. Many companies also engage third parties who specialize in coordinating technical support services. This is especially important for technical support of enterprise-class hardware systems, such as mainframe servers and high-end storage systems, because expensive parts and expensive replacement procedures warrant specialized skills.

### SUMMARY

The illustrative embodiments provide for optimal selection of a service request response team. An embodiment includes creating a first action item record corresponding to a first action item of a plurality of action items of an action plan record that is responsive to a service request, the first action item record comprising a first service requirement of the first action item. The embodiment also includes executing a first querying process that searches vendor records stored in a database for candidate vendors associated with the first service requirement, the first querying process resulting in a first set of candidate vendors. The embodiment also includes updating the first action item record with the first set of candidate vendors. The embodiment also includes determining an optimal vendor team from among a plurality of candidate vendors of the plurality of action items, the plurality of candidate vendors including the first set of candidate vendors, based at least in part on reputation data and cost data associated with each of the plurality of candidate vendors. The embodiment also includes updating the action plan record to include the optimal vendor team, where the updating of the action plan record triggers creation of a vendor team dispatch request. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example dynamic management system implemented as part of a ticket management system in accordance with an illustrative embodiment;

FIG. 4 depicts an example dynamic management system implemented as part of a service infrastructure in accordance with an illustrative embodiment;

FIG. 5 depicts a block diagram of an example dynamic management system implemented as a stand-alone application in any desired and practicable computing environment in accordance with an illustrative embodiment;

FIG. 6 depicts an example online-analytics dynamic management system in accordance with an illustrative embodiment;

FIG. 7 depicts an example offline-analytics dynamic management system in accordance with an illustrative embodiment; and

FIG. 8 depicts a flowchart of an example process for optimal selection of a service request response team in accordance with an illustrative embodiment.

### DETAILED DESCRIPTION

Technical support coordinators typically receive requests for technical assistance in the form of service requests, which are also commonly referred to as tickets. When a technical support coordinator receives a service request, they will typically review the service request and create an action plan. An action plan, as referred to herein, involves a plan for resolving a service request for a single type of system (also referred to as machine type (MT)). If the service request involves more than one system, a separate action plan will be created for each system.

An action plan includes specific actions—referred to as action items—to be taken in response to a service request. There are many possible approaches to creating an action plan. A technical support coordinator may prepare an action plan based on specific actions that were taken to resolve a similar issue in a previous service request. Alternatively, a Subject Matter Expert (SME), who is typically an experienced support provider with expertise on such systems (MTs) will review the service request and prepare an action plan based on their knowledge and experience, available documentation for the particular MT involved with the service request, consultation with the manufacturer of the MT, or other available resources. As another alternative, an artificial intelligence (AI) based system may review the service request and prepare an action plan, for example using natural language processing (NLP), such as text classification techniques combined with a corpus of information (a domain-specific ontology) regarding the resolution of past service requests.

Once an action plan has been created, the technical support coordinator uses a computerized scheduling system to assign the service request with the action plan to a service provider (also referred to herein as a vendor). In some cases, the scheduling system contacts a service provider that is predetermined or determined according to an ordered list of alternate service providers who can support the given type of hardware system (MT). For example, the technical support coordinator's organization may have contracts or similar arrangements with multiple service providers to establish policies and procedures, fee arrangements, types of services, and/or other considerations. Typically, the scheduling system cycles through the service providers such that each new service request is simply assigned to the next service provider in line who is eligible to provide support for the specific MT.

Prior scheduling systems generally offered limited flexibility and functionality in terms of how service providers are selected and assigned service requests. For example, prior scheduling systems only allowed for assigning one service provider to a service request. Also, as mentioned above, prior scheduling systems typically assigned each service request to a service provider that is “next in line” by cycling through a sequence of contracted entities. There are several problems that arise with such systems. In some cases, such systems may assign a service provider to a service request who lacks the parts or skills to properly complete the action plan, or who has scheduling conflicts that will lead to delays or otherwise lacks the ability to begin or complete the work in a timely manner, or who has a poor reputation with the entity that submitted the service request. This can be problematic not only from a customer satisfaction standpoint but may also rise to contractual issues where the technical support provider has a service level agreement (SLA) in place with the customer making the service request. An SLA is a contract covering support of a given hardware system for a given customer, and in some cases, it may stipulate one or more time constraints for such things as addressing and resolving service requests (e.g., the support provider will successfully resolve any service request within 24 hours). However, if the “next in line” service provider who is selected does not have the part available in a location from which the part can be delivered to the customer within 24 hours, then the contract SLA will be missed, which causes customer dissatisfaction and may even trigger contract-stipulated penalties.

The illustrative embodiments recognize and take into account that a service provider assigned to a service request by prior scheduling systems may be a less than optimal choice. A service provider may lack the parts or skills to properly complete the action plan, may have scheduling conflicts that will lead to delays, may have a poor reputation with the entity that submitted the service request, or may not be the optimal choice for various other reasons. The illustrative embodiments recognize and take into account that prior scheduling systems lacked visibility into various relevant data held locally and/or by service providers that could be processed and leveraged to make better-informed selections of service providers. The illustrative embodiments also recognize and take into account that a best response to a service request may involve a combination of two or more service providers that can best handle respective different action items. As a non-limiting example, a service plan may include an action item that involves replacing a part and another action item that involves technical troubleshooting tasks. One service provider may have the required replacement part on hand but lacks the expertise needed for the other action item. Another service provider has the expertise to do the troubleshooting but does not have the required replacement part. In such a scenario, assigning the service request to a combination of the two service providers is a better option than assigning the service request to either service provider individually.

In some embodiments of the present disclosure, system, methods, and algorithms may be presented to automatically retrieve and rank digital service provider records associated with respective candidate service providers by values in their respective records, or derived from their respective records, which provide one or more indicators of likelihood of success. Automatic or semi-automatic algorithms may be provided to automatically generate a data structure from one or more digital service provider records assembled from data that includes data from respective remote databases. In some embodiments, the methods of the present disclosure do not require human intervention to query and retrieve candidate service providers, from which one or more service providers will be selected to respond to the service request, resulting in an efficient and optimizing approach.

In an illustrative embodiment, a dynamic management system is a computerized or processor-based system that includes at least one processing unit (“processor”) to perform various computational and data processing tasks, as well as other functionality. The dynamic management system comprises one or more processing units is in communication with an electronic computer memory. In some embodiments, the memory comprises one or more computer readable storage media with program instructions collectively stored on the one or more computer readable storage media, with the program instructions being executable by one or more processors to cause the one or more processors to perform operations described herein.

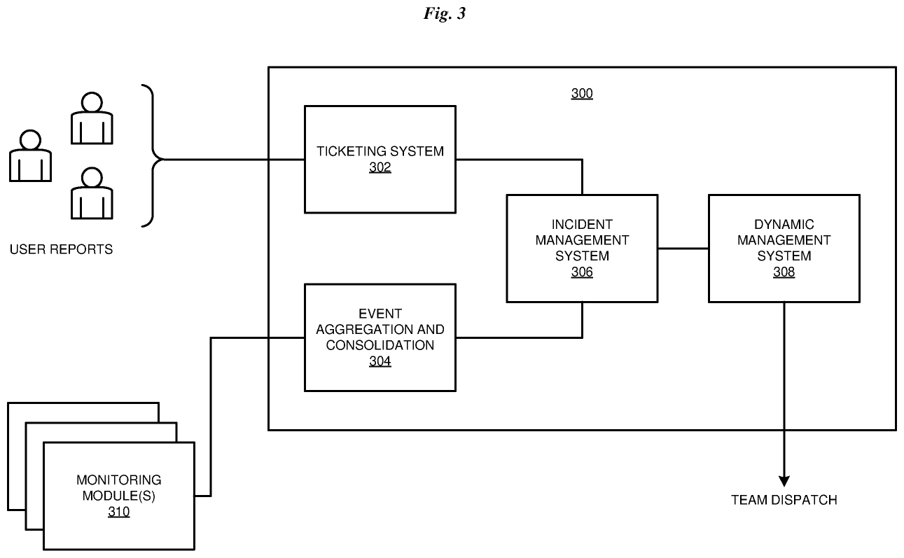

In an illustrative embodiment, the dynamic management system receives a service request. In some embodiments, the service request may originate from a user or from a system monitor (e.g., such as monitoring module(s) of FIG. 3). For example, a service request may originate as ticket data recorded by system administrators responsive to a user report or a notification from a system monitor. In some embodiments, a service request exists in digital form and includes ticket data representative of information as reported by a customer describing experienced problem symptoms or a new service needed. In some embodiments, ticket data contains both pre-defined, structured fields (e.g., problem type, support person/group handling the problem, ticket creation date, failure cause, failure class fields, etc.) as well as unstructured fields (e.g., open ended text describing problems and solutions as entered by the support administrators). In some embodiments, ticket data includes a problem description supplied by a user. In some embodiments, if the ticket has been resolved, the ticket data also includes resolution data, which describes the solution to the problem described in the ticket. In some such embodiments, the resolution data can be referenced to determine a solution for another ticket that describes the same or a similar problem.

In an illustrative embodiment, the dynamic management system is configured to recognize that a service request has been received. In some embodiments, the dynamic management system detects receipt of the service request. In some embodiments, the service request includes an action plan and one or more action items that have been prepared using any known technique. An action plan may include any number of action items, and the action items may vary depending on what needs to be accomplished to resolve the corresponding service request. For the sake of clarity, Table 1 shown below is a non-limiting example of an action plan that includes four action items (AIs):

TABLE 1

| AI # | AI DESCRIPTION |
|---|---|
| 1. | Further troubleshooting power supply system |
| 2. | Replace power backplane board |
| 3. | Replace power wiring harness |
| 4. | Update software |

Alternatively, the dynamic management system stores the service request until it receives an action plan with one or more action items for resolving the service request.

Responsive to receiving the service request and action plan, the dynamic management system creates an action item record for each action item in the action plan. The action item records each include a respective service requirement (e.g., “troubleshooting power supply system” for action item 1 in Table 1). Each action item record may include additional information, such as an action plan identifier (ID) so that the action item can easily be associated with the action plan it belongs to. Each action item may also include additional details about the actions to be taken, for example location and point-of-contact information, system details, part numbers, and service history of the system that is the subject of the service request.

In some embodiments, the dynamic management system generates one or more queries for information that it will use to determine an optimal response team for the corresponding service request. In some such embodiments, the dynamic management system uses natural language processing (NLP) to process information in an action item record, for example to identify a type of action (e.g., part replacement or troubleshooting) or a service requirement (e.g., replacement part or system expertise) of the action item.

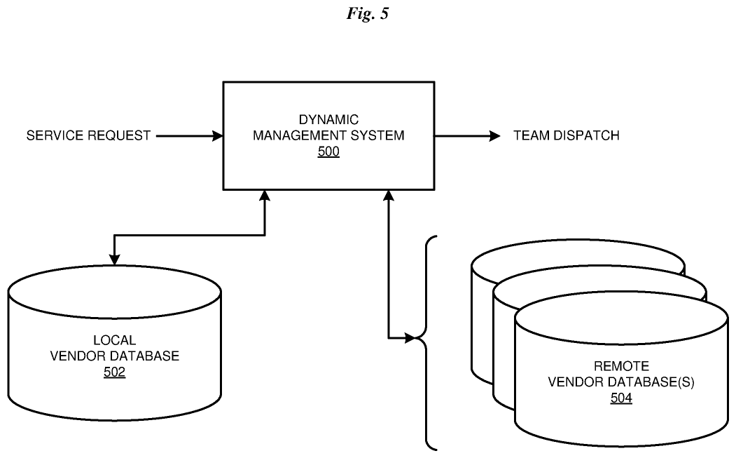

In some embodiments, the dynamic management system may operate in an online mode in which it queries numerous different remote databases (e.g., remote vendor database(s) shown in FIG. 5). In some embodiments, the remote databases may include databases that are maintained by respective different service providers (or vendors) that may have various different requirements for performing a query. For example, different vendor databases will have different connection information (e.g., Internet protocol (IP) addresses or Uniform Resource Locators (URLs)), they may have data organized differently, they may have respective application programming interfaces (APIs) with different API specifications, they may or may not require some form of authentication, or other differences. Additionally, or alternatively, the dynamic management system may operate in an offline mode in which it queries locally stored data that is periodically updated by an offline data analytics module.

In order to allow the dynamic management system to have visibility into vendor databases or other such sources of information, in some embodiments the dynamic management system maintains rules for each of the available remote databases, where the rules specify how to form a query for each respective database. In some embodiments, the dynamic management system also maintains rules for each available local database (i.e., where local databases refer to databases maintained by the service coordinator rather than by a third-party service provider or vendor).

In an illustrative embodiment, the dynamic management system issues queries to one or more of the remote requirements databases. Each query issued to the remote requirements database will be associated with a specific action item and will be constructed to search vendor records in order to identify candidate vendors that can satisfy a service requirement of the specific action item. For example, for the first action item in Table 1 below, the dynamic management system will issue queries to one or more remote vendor databases to identify vendors that have the ability to perform the required troubleshooting; for the second action item in Table 1, the dynamic management system will issue queries to one or more remote vendor databases to identify vendors that have the required replacement part available in inventory. In some embodiments, the dynamic management system may also retrieve information as available regarding cost and availability for each candidate vendor.

In some embodiments, the dynamic management system updates the action item record with information about each candidate vendor that was found for that specific action item. Thus, for the example shown in Table 1 below, each of the four action items will have a respective list of candidate vendors. It is therefore possible that the list of candidate vendors for each of the four action items may be completely different (i.e., the lists are mutually exclusive), or may be partially or completely the same depending on the query results.

In some embodiments, once the dynamic management system has completed the queries for an action item, the result of the queries will include a list of one or more candidate vendors for the action item. In some such embodiments, the dynamic management system issues queries corresponding to each of the candidate vendors to a local reputation database. In some embodiments, the reputation database includes reputation data indicative of historical data for the candidate vendor, such as information regarding one or more past service requests assigned to a candidate vendor and how satisfied or unsatisfied the customer was with the candidate vendor's performance of the assigned action item. In some embodiments, the reputation database may include a reputation score indicative of a level of customer satisfaction for one or more past service requests handled by the candidate vendor. In some embodiments, the dynamic management system updates the action item record with the reputation data resulting from querying the reputation database for each candidate vendor.

In some embodiments, the dynamic management system will generate queries for each of the action items in an action plan and will issue queries and retrieve query results for each action item in an action plan. Once all of the queries are completed for an action plan, the dynamic management system determines an optimal vendor team from among the one or more candidate vendors for each of one or more action items in the action plan. In some embodiments, the dynamic management system determines one or more optimal vendors for each action item based at least in part on the data retrieved from the queries, for example based at least in part on reputation data and/or based at least in part on cost and/or parts availability data associated with each of the plurality of candidate vendors.

In some embodiments, the dynamic management system determines the optimal vendor team by maximizing reputation scores using the reputation data while minimizing cost using the cost data. For example, in some embodiments, the reputation data can be represented as a risk of contract nonrenewal, in which case the goal of team optimization can be represented according to Expression 1 below.

Optimization=min(ƒ′(RcontrSR,NTCost)) (1)

In Expression 1, RcontrSR represents a contract nonrenewal risk introduced by a current service request (SR) vendor (team) assignment and NTCost is a normalized team cost of servicing this SR in addition to risk. In some embodiments, RcontrSR is a function of team risk metrics and customer risk metrics as shown in Expression (2):

RcontrSR=ƒ(RTSla,TNps,NContrTCV,NcontrTime,CNps) (2)

In Expression (2), RTSla and TNps are team (risk) metrics and v NContrTCV, NcontrTime, and CNps are customer (risk) metrics. These values are explained below:
1. Vendor: V; individual vendors may be referenced as Vᵢ
2. Team Vtᵢ as input to the optimization algorithm is a team of one or multiple vendors
3. Cost of getting the SR serviced by vendor Vᵢ=Vcostᵢ, which includes the cost of parts used by the vendor
   a. TCostⱼ=cumulative cost of all vendors selected to form VTⱼ to service the SR
   b. Normalized cost NTCost_{j.}0<NTCostⱼ≤1.0
4. Vendor reputation: VNpsᵢ, which is continuously updated
   a. 0<VNpsᵢ, <100 or normalized such that 0≤VNpsᵢ≤1.0
   b. TNpsⱼ: adjusted vendor (team) NPS by using multiple vendors in VTⱼ to service the SR
5. Risk of service level agreement (SLA) deadline miss for a vendor:
   a. Risk of vendor Vᵢ, missing time-to-contact (TTC) SLA (support provider has to be at the site): 0≤RVSlaTTCᵢ≤1.0
   b. Risk of vendor Vᵢ, missing time-to-service (TTS) SLA (all parts have to be available at site): 0≤RVSlaTTSᵢ≤1.0
      i. RVSlaTTSᵢ is currently based on getting parts to the site. But TTS involves labor and problem determination also.
   c. Risk of vendor Vᵢ missing overall SLA for vendor: RVSlaᵢ
   d. RTSlaⱼ: risk of the SR missing SLAs when ≥1 vendor is used to form team VTⱼ to service the SR
6. Normalized customer contract Total Contract Value (TCV) is percentage/ratio of total TCV of all active contracts for that customer
   a. 0<NContrTCV<1.0
7. Normalized contract age already over based on total contract duration: 0≤NContrTime≤1.0
8. Customer NPS (across all contracts and all service providers): 0≤CNps≤1.0

As a non-limiting example, an optimal team selection for service request involving the replacement of three parts P1, P2, and P3 results in an action plan having three action items, one for each part replacement. Queries reveal five vendors (V1, V2, V3, V4, and V5) that are available, but only one vendor has all three parts available, three vendors have two parts available, and one vendor has none of the parts available: V1 has P1 and P2; V2 has P1 and P3; V3 has P2 and P3, and V4 has P1, P2, and P3. V5 has none of the parts but has a very high reputation score. The dynamic management system can form seven possible teams Vt_1-Vt_7 from combinations of V1-V5 as follows: Vt_1={V1, V2}, Vt_2={V1, V3}, Vt_3={V2, V3}, Vt_4={V4}, Vt_5={V1, V4}, Vt_6={V2, V4}, Vt_7={V3, V4}. The system can also form seven additional teams Vt8-Vt14, which are the teams Vt1-Vt7 with V5 added to the team. Each team has all required parts. Each team Vti is processed to determine which team best satisfies Expression (1) above:
1. TCost_{j.}=ΣVcostᵢ (sum for all Vᵢ in team Vtⱼ)
   a) Normalized cost NTCost_{j.}=(TCost_{j.})/ContrTCV, 0<NTCostⱼ≤1.0
2. TNpsᵢ:=∀Vᵢ, mean (VNpsᵢ) (for all Vᵢ in team Vtⱼ)
   a) Alternate formulation, assuming the best vendor elevates the overall quality of service
   b) TNpsⱼ=∀Vᵢ, max(VNpsᵢ)
3. RTSlaₖ: this is a ‘probability’ of missing the SLA for this SR for team_k
   a) Combining 2 vendors can reduce risk.
   b) If the best vendor in step 3 meets all requirements (including parts) but is simply not close enough to meet time-to-contact SLA (and per step 3, nobody else can), then we cannot improve this risk of missing the TTC by combining vendors.
   c) Combining vendors to reduce SLA miss risk helps when no vendor has all the parts.
   d) Combining vendors may help to reduce contract nonrenewal risk even if above condition not met.
   e) RVSlaᵢ has two parts:
      (i) One factor for vendor Vᵢ is how far away from the customer site is the nearest SSR
      (ii) Another factor to consider is the length of time it will take for the vendor to get all available parts to the site and replace them
   f) RVSlaTTCᵢ=max(timeToContactSla, estimated time for Vᵢ to reach customer site)/timeToContactSla
   g) RVSlaTTCᵢⱼ=max(timeToServiceSla, estimated time for Vᵢ to get partⱼ to customer site+(timeToSvcᵢⱼ)/
   h) RVSlaTTSᵢ=∀partⱼ max(RVSlaTTSᵢⱼ)
      (i) Some embodiments enumerate multi-vendor teams when no vendor has all parts, before the optimization step
   i) RVSlaTTCₖ=min(RVSlaTTCᵢ) for all Vᵢ in team Vₜₖ
   j) RVSlaTTS_{K}=∀Vi, max(RVSlaTTSᵢ) for all Vᵢ in team Vₜₖ
      (i) The above applies trivially to a team of one vendor who has all parts in order to be in a “team”

In some embodiments, once the dynamic management system has generated an optimal team, the dynamic management system creates a vendor team dispatch request for each vendor on the optimized team. In some embodiments, the dynamic management system forwards the dispatch request to each of the vendors on the optimized team. In some embodiments, the dispatch request includes information regarding the action item(s) assigned to the vendor.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, historical data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

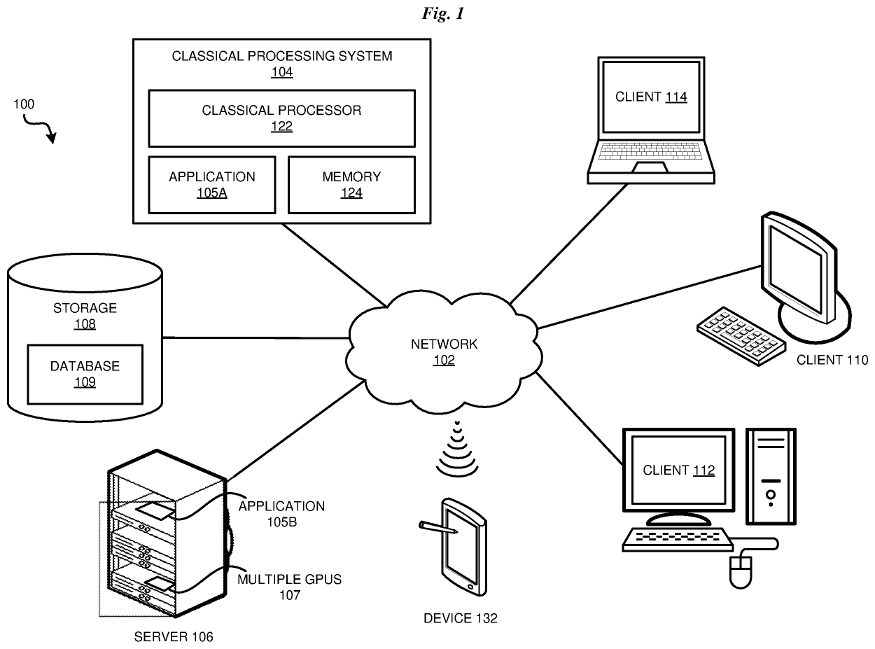

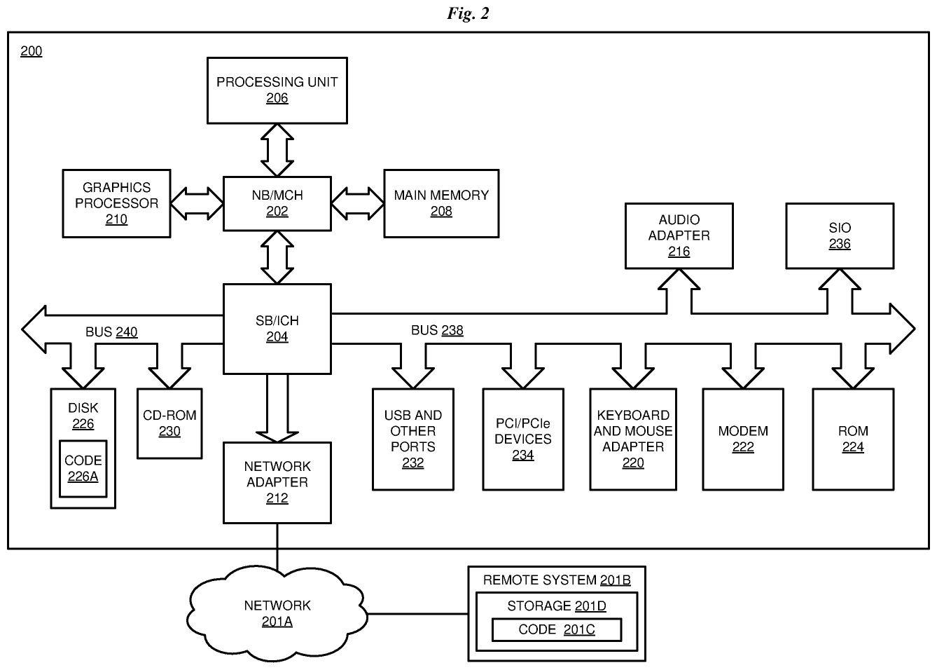

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

With reference to FIG. 1, this figure depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Data processing system 104 couples to network 102. Software applications may execute on any data processing system in data processing environment 100. Any software application described as executing in processing system 104 in FIG. 1 can be configured to execute in another data processing system in a similar manner. Any data or information stored or produced in data processing system 104 in FIG. 1 can be configured to be stored or produced in another data processing system in a similar manner. A data processing system, such as data processing system 104, may contain data and may have software applications or software tools executing computing processes thereon. In an embodiment, data processing system 104 includes memory 124, which includes application 105A that may be configured to implement one or more of the data processor functions described herein in accordance with one or more embodiments.

Server 106 couples to network 102 along with storage unit 108. Storage unit 108 includes a database 109 configured to store data as described herein with respect to various embodiments, for example image data and attribute data. Server 106 is a conventional data processing system. In an embodiment, server 106 includes application 105B that may be configured to implement one or more of the processor functions described herein in accordance with one or more embodiments.

Clients 110, 112, and 114 are also coupled to network 102. A conventional data processing system, such as server 106, or clients 110, 112, or 114 may contain data and may have software applications or software tools executing conventional computing processes thereon.

Only as an example, and without implying any limitation to such architecture, FIG. 1 depicts certain components that are usable in an example implementation of an embodiment of a network that includes a client/server implementation of an application that provides cognitive analysis of a project description. For example, server 106, and clients 110, 112, 114, are depicted as servers and clients only as example and not to imply a limitation to a client-server architecture. As another example, a distributed embodiment of an application that provides cognitive analysis of a project description can be distributed across several data processing systems, and a data network as shown, whereas another embodiment of an application that provides cognitive analysis of a project description can be implemented on a single data processing system within the scope of the illustrative embodiments. Conventional data processing systems 106, 110, 112, and 114 also represent example nodes in a cluster, partitions, and other configurations suitable for implementing an embodiment.

Device 132 is an example of a conventional computing device described herein. For example, device 132 can take the form of a smartphone, a tablet computer, a laptop computer, client 110 in a stationary or a portable form, a wearable computing device, or any other suitable device. In an embodiment, device 132 sends requests to server 106 to perform one or more data processing tasks by application 105B such as initiating processes described herein that provide cognitive analysis of project descriptions. Any software application described as executing in another conventional data processing system in FIG. 1 can be configured to execute in device 132 in a similar manner. Any data or information stored or produced in another conventional data processing system in FIG. 1 can be configured to be stored or produced in device 132 in a similar manner.

Server 106, storage unit 108, data processing system 104, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 106 may provide data, such as boot files, operating system images, and applications to clients 110, 112, and 114. Clients 110, 112, and 114 may be clients to server 106 in this example. Clients 110, 112, 114, or some combination thereof, may include their own data, boot files, operating system images, and applications. Data processing environment 100 may include additional servers, clients, and other devices that are not shown.

In the depicted example, memory 124 may provide data, such as boot files, operating system images, and applications to processor 122. Processor 122 may include its own data, boot files, operating system images, and applications. Data processing environment 100 may include additional memories, processors, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a conventional client data processing system and a conventional server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a conventional computer, such as data processing system 104, server 106, or clients 110, 112, and 114 in FIG. 1, or another type of device in which computer usable program code or instructions implementing the processes may be located for the illustrative embodiments.

Data processing system 200 is also representative of a conventional data processing system or a configuration therein, such as conventional data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid-state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. In another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

With reference to FIG. 3, this figure depicts a block diagram of an example dynamic management system 308 implemented as part of a ticket management system 300 in accordance with an illustrative embodiment. In a particular embodiment, the example ticket management system 300 is an example of applications 105A/105B of FIG. 1.

In the illustrated embodiment, the ticket management system 300 comprises a ticketing system 302 and an event aggregation and consolidation module 304. Various monitoring module(s) 310 may monitor a computing environment via respective probes. Monitoring module(s) 310 may include, but are not limited to, a server hardware monitoring module, which for example, may monitor server hardware for performance, problems or any other events related to the computing environment's server hardware; an operating system/hypervisor monitoring module that may monitor one or more operating systems and hypervisors; a guest virtual machine (VM) monitoring module that may monitor VMs, which may include a container monitoring module that may monitor a container running on a VM; a network monitoring module that may monitor network elements and traffic; and a storage monitoring module that may monitor storage devices and related performance and traffic. Those various monitoring modules may look for problems, determine what is happening in the system with respect to the devices that the monitoring modules are monitoring, and may generate one or more events and/or logs related to their monitoring, e.g., if abnormal behavior is detected. Those monitoring modules may also automatically generate problem tickets.

Event aggregation and consolidation module 304 may receive the events and/or logs from one or more monitoring module(s) 310, identify problematic events and/or logs and send those events that are determined to be abnormal events, for instance, those that indicate behavior of the devices that might signal a problem to an incident management system 306. Similarly, a ticketing system 302 may also generate one or more events or problem logs based on user reports and send the one or more events to the incident management system 306. The incident management system 306 may create tickets (also referred to herein as service requests) associated with the events it receives, and open the tickets, for instance, to be handled by the dynamic management system 308.

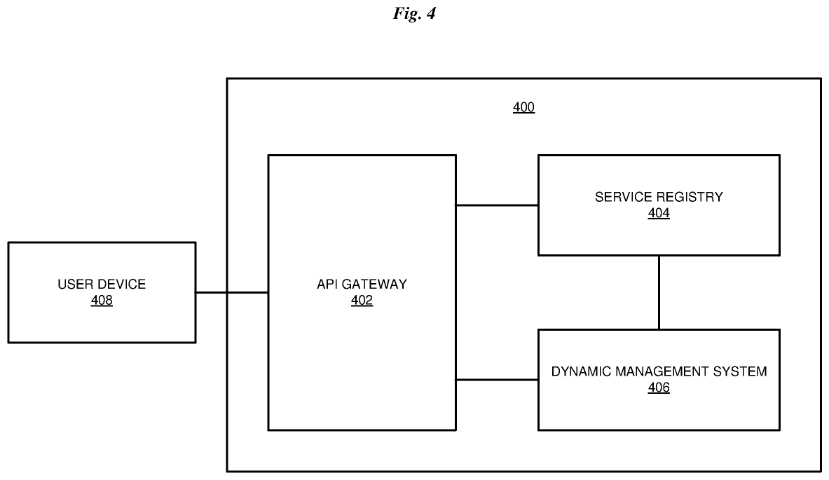

With reference to FIG. 4, this figure depicts an example dynamic management system 406 implemented as part of a service infrastructure 400 in accordance with an illustrative embodiment. In some embodiments, the dynamic management system 406 is hosted on a server and is an example of applications 105A/105B of FIG. 1.

In the illustrated embodiment, the service infrastructure 400 provides services and service instances to a user device 408. User device 408 communicates with service infrastructure 400 via an API gateway 402. In various embodiments, service infrastructure 400 and its associated dynamic management system 406 serve multiple users and multiple tenants. A tenant is a group of users (e.g., a company) who share a common access with specific privileges to the software instance. Service infrastructure 400 ensures that tenant specific data is isolated from other tenants.

In some embodiments, user device 408 connects with API gateway 402 via any suitable network or combination of networks such as the Internet, etc. and use any suitable communication protocols such as Wi-Fi, Bluetooth, etc. Service infrastructure 400 may be built on the basis of cloud computing. API gateway 402 provides access to client applications like automated decision system 406. API gateway 402 receives service requests issued by client applications and creates service lookup requests based on service requests. As a non-limiting example, in an embodiment, the user device 408 is ticket management system that utilizes the dynamic management system 406 to determine optimal vendor teams for responding to tickets.

In the illustrated embodiment, service infrastructure 400 includes a service registry 404. In some embodiments, service registry 404 looks up service instances of dynamic management system 406 in response to a service lookup request such as one from API gateway 402 in response to a service request from user device 408. For example, in some embodiments, the service registry 404 looks up service instances of dynamic management system 406 in response to requests from the user device 408 related to generating action items, determining candidate vendors for each action item, and determining an optimal vendor team for responding to a ticket or service request.

In some embodiments, the service infrastructure 400 includes one or more instances of the dynamic management system 406. In some such embodiments, each of the multiple instances of the dynamic management system 406 run independently on multiple computing systems. In some such embodiments, dynamic management system 406, as well as other service instances of dynamic management system 406, are registered in service registry 404.

In some embodiments, service registry 404 maintains information about the status or health of each service instance including performance information associated each of the service instances. For example, such performance information may include several types of performance characteristics of a given service instance (e.g., cache metrics, etc.). In some embodiments, the extended service registry 404 ranks service instances based on their respective performance characteristics and selects top-ranking service instances for classification requests. In some such embodiments, in the event that a service instance becomes unresponsive or, unhealthy, the service registry will no longer provide its address or information about this service instance to other services.

With reference to FIG. 5, this figure depicts a block diagram of an example dynamic management system 500 implemented as a stand-alone application in any desired and practicable computing environment in accordance with an illustrative embodiment. In a particular embodiment, the dynamic management system 500 is an example of applications 105A/105B of FIG. 1.

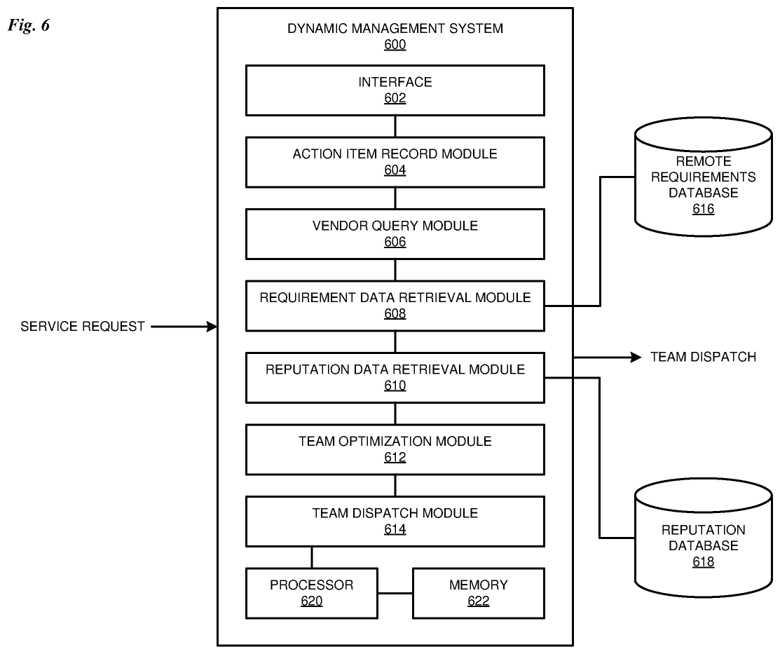

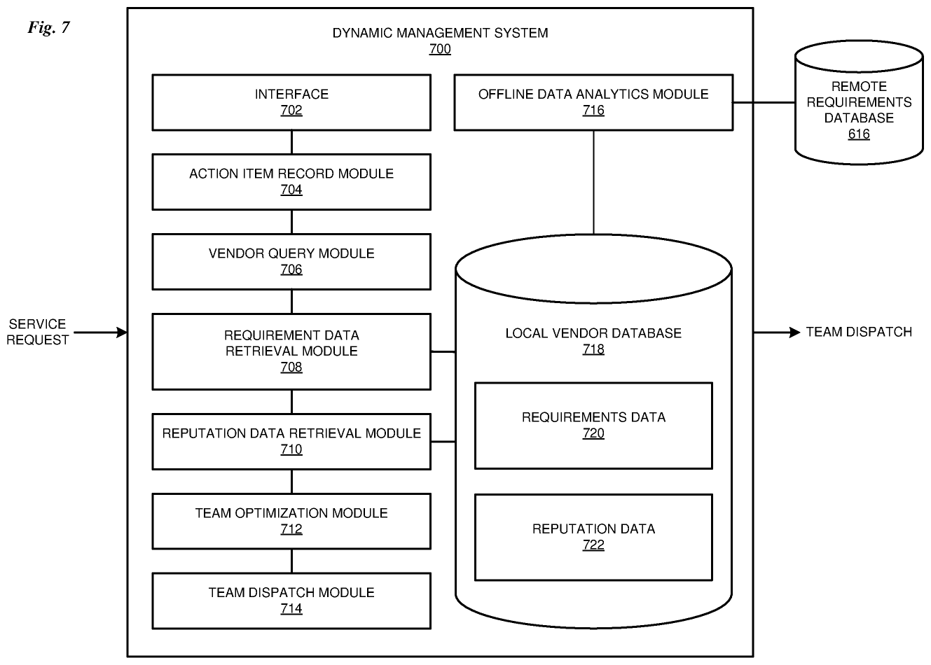

In the illustrated embodiment, the dynamic management system 500 receives a service request (e.g., ticket). Responsive to receiving the service request, the dynamic management system 500 creates action item records corresponding to action items of an action plan that has been determined using known techniques. The dynamic management system 500 issues one or more queries to one or more data stores for candidate vendors associated with service requirements of the action items. The dynamic management system 500 may be implemented according to an online analytics embodiment (shown in more detail in FIG. 6) that queries remote vendor database(s) 504 and/or according to an offline analytics embodiment (shown in more detail in FIG. 7) that queries local vendor database rendering module 502. In response to the query or queries, the dynamic management system 500 receives a set of candidate vendors for each action item. The dynamic management system 500 determines an optimal vendor team from among the received sets of candidate vendors using, for example, reputation data and cost data associated with each of the plurality of candidate vendors. The dynamic management system 500 updates the action plan record to include the optimal vendor team, which triggers the automatic creation of a vendor team dispatch request that is output from the dynamic management system 500.

With reference to FIG. 6, this figure depicts an example online-analytics dynamic management system 600 in accordance with an illustrative embodiment. In a particular embodiment, the dynamic management system 600 is an example of dynamic management system 308 of FIG. 3, dynamic management system 406 of FIG. 4, or dynamic management system 500 of FIG. 5.

In the illustrated embodiment, the dynamic management system 600 comprises an interface 602, an action item record module 604, a vendor query module 606, a requirement data retrieval module 608 in communication with a remote requirements database 616, a reputation data retrieval module 610 in communication with a reputation database 618, a team optimization module 612, and a team dispatch module 614. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the dynamic management system 600 is a computerized or processor-based system that includes at least one processing unit (“processor”) 620 to perform various computational and data processing tasks, as well as other functionality. The processing unit 620 is in communication with an electronic computer memory 622. In some embodiments, the memory 622 comprises one or more computer readable storage media with program instructions collectively stored on the one or more computer readable storage media, with the program instructions being executable by one or more processors 620 to cause the one or more processors 620 to perform operations described herein.

In the illustrated embodiment, interface 602 receives a service request. In some embodiments, the service request may originate from a user or from a system monitor, such as monitoring module(s) 310 of FIG. 3. For example, a service request may originate as ticket data recorded by system administrators responsive to a user report or a notification from a system monitor. In some embodiments, a service request exists in digital form and includes ticket data representative of information as reported by a customer describing experienced problem symptoms or a new service needed. In some embodiments, ticket data contains both pre-defined, structured fields (e.g., problem type, support person/group handling the problem, ticket creation date, failure cause, failure class fields, etc.) as well as unstructured fields (e.g., open ended text describing problems and solutions as entered by the support administrators). In some embodiments, ticket data includes a problem description supplied by a user. In some embodiments, if the ticket has been resolved, the ticket data also includes resolution data, which describes the solution to the problem described in the ticket. In some such embodiments, the resolution data can be referenced to determine a solution for another ticket that describes the same or a similar problem.

In the illustrated embodiment, the interface 602 is configured to recognize that a service request has been received and forward the service request to the action item record module 604. In some embodiments, the action item record module 604 detects receipt of the service request. In some embodiments, the service request includes an action plan and one or more action items that have been prepared using any known technique. An action plan may include any number of action items, and the action items (e.g., as shown in Table 1 above) may vary depending on what needs to be accomplished to resolve the corresponding service request. Alternatively, the action item record module 604 stores the service request until it receives an action plan with one or more action items for resolving the service request.

Responsive to receiving the service request and action plan, the action item record module 604 creates an action item record for each action item in the action plan. The action item records each include a respective service requirement (e.g., “troubleshooting power supply system” for action item 1 in Table 1). Each action item record may include additional information, such as an action plan identifier (ID) so that the action item can easily be associated with the action plan it belongs to. Each action item may also include additional details about the actions to be taken, for example location and point-of-contact information, system details, part numbers, and service history of the system that is the subject of the service request. In some embodiments, the action item record module 604 notifies the vendor query module 606 that one or more new action item records have been created. In some embodiments, the action item record module 604 forwards each of the action item records, or pointers to the action item records, to the vendor query module 606.

In some embodiments, the vendor query module 606 receives or fetches an action item record and generates one or more queries for information that will be used by the team optimization module 612 to determine an optimal response team for the corresponding service request. In some such embodiments, the vendor query module 606 uses natural language processing (NLP) to process information in an action item record, for example to identify a type of action (e.g., part replacement or troubleshooting) or a service requirement (e.g., replacement part or system expertise) of the action item.

In some embodiments, the dynamic management system 600 may query numerous different remote databases, such as remote vendor database(s) 504 shown in FIG. 5, which are collectively shown as remote requirements database 616 in FIG. 6. In some embodiments, the remote databases may include databases that are maintained by respective different service providers (or vendors) that may have various different requirements for performing a query. For example, different vendor databases will have different connection information (e.g., IP addresses or URLs), they may have data organized differently, they may have respective APIs with different API specifications, they may or may not require some form of authentication, or other differences.

In order to allow the dynamic management system 600 to have visibility into vendor databases or other such sources of information, in some embodiments the vendor query module 606 maintains rules for each of the available remote databases, where the rules specify how to form a query for each respective database. In some embodiments, the vendor query module 606 also maintains rules for each available local database (i.e., where local databases refer to databases maintained by the service coordinator rather than by a third-party service provider or vendor).

In the illustrated embodiment, a requirement data retrieval module 608 issues queries generated by the vendor query module 606 to one or more of the remote requirements databases 616. Each query issued to the remote requirements database 616 will be associated with a specific action item and will be constructed to search vendor records in order to identify candidate vendors that can satisfy a service requirement of the specific action item. For example, for the first action item in Table 1 above, the requirement data retrieval module 608 will issue queries to one or more remote vendor databases to identify vendors that have the ability to perform the required troubleshooting; for the second action item in Table 1, the requirement data retrieval module 608 will issue queries to one or more remote vendor databases to identify vendors that have the required replacement part available in inventory. In some embodiments, the requirement data retrieval module 608 may also retrieve information as available regarding cost and availability for each candidate vendor.

In some embodiments, the requirement data retrieval module 608 updates the action item record with information about each candidate vendor that was found for that specific action item. Thus, for the example shown in Table 1 above, each of the four action items will have a respective list of candidate vendors. It is therefore possible that the list of candidate vendors for each of the four action items may be completely different (i.e., the lists are mutually exclusive), or may be partially or completely the same depending on the query results.

In some embodiments, once the requirement data retrieval module 608 has completed the queries for an action item, the result of the queries will include a list of one or more candidate vendors for the action item. In some such embodiments, the reputation data retrieval module 610 issues queries (which may include queries generated by the vendor query module 606) corresponding to each of the candidate vendors to a local reputation database 618. In some embodiments, the reputation database 618 includes reputation data indicative of historical data for the candidate vendor, such as information regarding one or more past service requests assigned to a candidate vendor and how satisfied or unsatisfied the customer was with the candidate vendor's performance of the assigned action item. In some embodiments, the reputation database 618 may include a reputation score indicative of a level of customer satisfaction for one or more past service requests handled by the candidate vendor. In some embodiments, the reputation data retrieval module 610 updates the action item record with the reputation data resulting from querying the reputation database 618 for each candidate vendor.

In some embodiments, the vendor query module 606 will generate queries for each of the action items in an action plan and the requirement data retrieval module 608 and reputation data retrieval module 610 will issue queries and retrieve query results for each action item in an action plan. Once all of the queries are completed for an action plan, the team optimization module 612 is triggered to determine an optimal vendor team from among the one or more candidate vendors for each of one or more action items in the action plan. In some embodiments, the team optimization module 612 determines one or more optimal vendors for each action item based at least in part on the retrieved by the reputation data retrieval module 610 and/or based at least in part on cost and/or parts availability data associated with each of the plurality of candidate vendors retrieved by the requirement data retrieval module 608 from the one or more remote requirements databases 616. In some embodiments, the team optimization module 612 determines the optimal vendor team according to a process that comprises maximizing reputation scores using the reputation data while minimizing cost using the cost data.

In some embodiments, once an optimal team has been generated by the team optimization module 612, the team dispatch module 614 is provided with the list of vendors. In response, the team dispatch module 614 triggers creation of a vendor team dispatch request for each vendor on the optimized team. In some embodiments, the team dispatch module 614 forwards the dispatch request to each of the vendors on the optimized team. In some embodiments, the dispatch request includes information regarding the action item(s) assigned to the vendor.

With reference to FIG. 7, this figure depicts an example offline-analytics dynamic management system 700 in accordance with an illustrative embodiment. In a particular embodiment, the dynamic management system 700 is an example of dynamic management system 308 of FIG. 3, dynamic management system 406 of FIG. 4, or dynamic management system 500 of FIG. 5.

In the illustrated embodiment, the dynamic management system 700 comprises an interface 702, an action item record module 704, a vendor query module 706, a requirement data retrieval module 708, a reputation data retrieval module 710, a team optimization module 712, a team dispatch module 714, an offline data analytics module 716, and a local vendor database 718 that stores requirements data 720 and reputation data 722. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the dynamic management system 700 is similar to dynamic management system 600 except where the description of dynamic management system 700 differs from that of dynamic management system 600. Like dynamic management system 600, dynamic management system 700 is a computerized or processor-based system that includes at least one processing unit (e.g., processor 620 shown in FIG. 6) in communication with an electronic computer memory (e.g., memory 622 shown in FIG. 6). In some embodiments, the memory 622 comprises one or more computer readable storage media with program instructions collectively stored on the one or more computer readable storage media, with the program instructions being executable by one or more processors 620 to cause the one or more processors 620 to perform operations described herein in connection with dynamic management system 700.

In the illustrated embodiment, interface 702 receives a service request. In some embodiments, the service request may originate from a user or from a system monitor, such as monitoring module(s) 310 of FIG. 3. For example, a service request may originate as ticket data recorded by system administrators responsive to a user report or a notification from a system monitor. In some embodiments, a service request exists in digital form and includes ticket data representative of information as reported by a customer describing experienced problem symptoms or a new service needed. In some embodiments, ticket data contains both pre-defined, structured fields (e.g., problem type, support person/group handling the problem, ticket creation date, failure cause, failure class fields, etc.) as well as unstructured fields (e.g., open ended text describing problems and solutions as entered by the support administrators). In some embodiments, ticket data includes a problem description supplied by a user. In some embodiments, if the ticket has been resolved, the ticket data also includes resolution data, which describes the solution to the problem described in the ticket. In some such embodiments, the resolution data can be referenced to determine a solution for another ticket that describes the same or a similar problem.

In the illustrated embodiment, the interface 702 is configured to recognize that a service request has been received and forward the service request to the action item record module 704. In some embodiments, the action item record module 704 detects receipt of the service request. In some embodiments, the service request includes an action plan and one or more action items that have been prepared using any known technique. As shown above in Table 1, an action plan may include any number of action items, and the action items may vary depending on what needs to be accomplished to resolve the corresponding service request. Alternatively, the action item record module 704 stores the service request until it receives an action plan with one or more action items for resolving the service request.

Responsive to receiving the service request and action plan, the action item record module 704 creates an action item record for each action item in the action plan. The action item records each include a respective service requirement (e.g., “troubleshooting power supply system” for action item 1 in Table 1). Each action item record may include additional information, such as an action plan identifier (ID) so that the action item can easily be associated with the action plan it belongs to. Each action item may also include additional details about the actions to be taken, for example location and point-of-contact information, system details, part numbers, and service history of the system that is the subject of the service request. In some embodiments, the action item record module 704 notifies the vendor query module 706 that one or more new action item records have been created. In some embodiments, the action item record module 704 forwards each of the action item records, or pointers to the action item records, to the vendor query module 706.

In some embodiments, the vendor query module 706 receives or fetches an action item record and generates one or more queries for information that will be used by the team optimization module 712 to determine an optimal response team for the corresponding service request. In some such embodiments, the vendor query module 706 uses natural language processing (NLP) to process information in an action item record, for example to identify a type of action (e.g., part replacement or troubleshooting) or a service requirement (e.g., replacement part or system expertise) of the action item.

In some embodiments, the dynamic management system 700 may operate in an offline mode in which it queries requirements data 720 stored in a local vendor database 718. In some embodiments, the requirements data 720 stored in a local vendor database 718 is periodically updated by an offline data analytics module 716 based on data retrieved from one or more different remote databases, such as remote vendor database(s) 504 shown in FIG. 5, which are collectively shown as remote requirements database 724 in FIG. 7. In some embodiments, the remote databases may include databases that are maintained by respective different service providers (or vendors) that may have various different requirements for performing a query. For example, different vendor databases will have different connection information (e.g., IP addresses or URLs), they may have data organized differently, they may have respective APIs with different API specifications, they may or may not require some form of authentication, or other differences.

In order to allow the dynamic management system 700 to have visibility into vendor databases or other such sources of information, in some embodiments the offline data analytics module 716 maintains rules for each of the available remote databases 724, where the rules specify how to form a query for each respective database. In some embodiments, the offline data analytics module 716 converts or otherwise processes the data retrieved from the one or more remote requirements database 724 so as to store the data in the local vendor database 718 in a uniform manner.

In the illustrated embodiment, a requirement data retrieval module 708 issues queries generated by the vendor query module 706 to the requirements data 720 of the local vendor database 718. Each query issued to the requirements data 720 of the local vendor database 718 will be associated with a specific action item and will be constructed to search vendor records in order to identify candidate vendors that can satisfy a service requirement of the specific action item. For example, for the first action item in Table 1 above, the requirement data retrieval module 708 will issue queries to the requirements data 720 of the local vendor database 718 in order to identify vendors that have the ability to perform the required troubleshooting; for the second action item in Table 1, the requirement data retrieval module 708 will issue queries to the requirements data 720 of the local vendor database 718 to identify vendors that have the required replacement part available in inventory. In some embodiments, the requirement data retrieval module 708 may also retrieve information as available regarding cost and availability for each candidate vendor.

In some embodiments, the requirement data retrieval module 708 updates the action item record with information about each candidate vendor that was found for that specific action item. Thus, for the example shown in Table 1 above, each of the four action items will have a respective list of candidate vendors. It is therefore possible that the list of candidate vendors for each of the four action items may be completely different (i.e., the lists are mutually exclusive), or may be partially or completely the same depending on the query results.

In some embodiments, once the requirement data retrieval module 708 has completed the queries for an action item, the result of the queries will include a list of one or more candidate vendors for the action item. In some such embodiments, the reputation data retrieval module 710 issues queries (which may include queries generated by the vendor query module 706) corresponding to each of the candidate vendors to reputation data 722 of the local vendor database 718. In some embodiments, the reputation database 722 includes reputation data indicative of historical data for the candidate vendor, such as information regarding one or more past service requests assigned to a candidate vendor and how satisfied or unsatisfied the customer was with the candidate vendor's performance of the assigned action item. In some embodiments, the reputation database 722 may include a reputation score indicative of a level of customer satisfaction for one or more past service requests handled by the candidate vendor. In some embodiments, the reputation data retrieval module 710 updates the action item record with the reputation data resulting from querying the reputation database 722 for each candidate vendor.

In some embodiments, the vendor query module 706 will generate queries for each of the action items in an action plan and the requirement data retrieval module 708 and reputation data retrieval module 710 will issue queries and retrieve query results for each action item in an action plan. Once all of the queries are completed for an action plan, the team optimization module 712 is triggered to determine an optimal vendor team from among the one or more candidate vendors for each of one or more action items in the action plan. In some embodiments, the team optimization module 712 determines one or more optimal vendors for each action item based at least in part on the retrieved by the reputation data retrieval module 710 and/or based at least in part on cost and/or parts availability data associated with each of the plurality of candidate vendors retrieved by the requirement data retrieval module 708 from the requirements data 720 and reputation data 722 of the local vendor database 718. In some embodiments, the team optimization module 712 determines the optimal vendor team according to a process that comprises maximizing reputation scores using the reputation data while minimizing cost using the cost data.

In some embodiments, once an optimal team has been generated by the team optimization module 712, the team dispatch module 714 is provided with the list of vendors. In response, the team dispatch module 714 triggers creation of a vendor team dispatch request for each vendor on the optimized team. In some embodiments, the team dispatch module 714 forwards the dispatch request to each of the vendors on the optimized team. In some embodiments, the dispatch request includes information regarding the action item(s) assigned to the vendor.

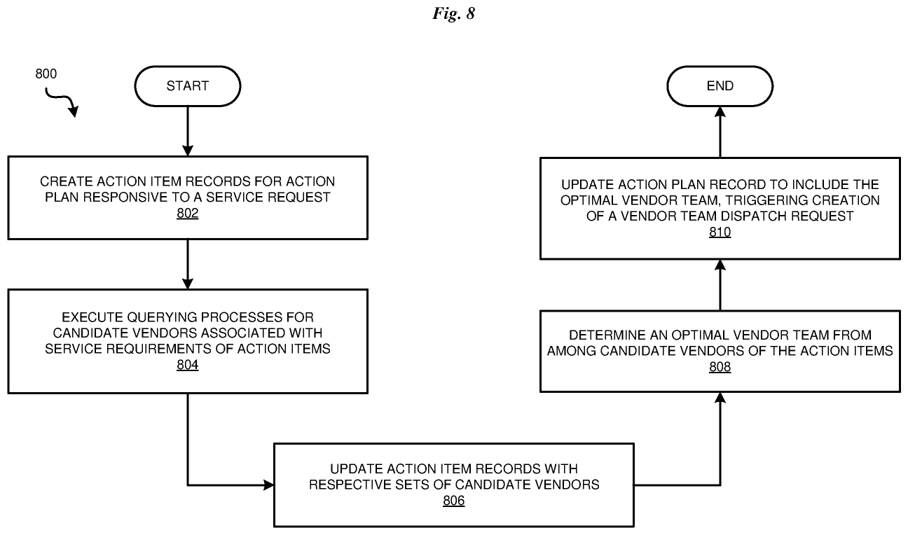

With reference to FIG. 8, this figure depicts a flowchart of an example process 800 for optimal selection of a service request response team in accordance with an illustrative embodiment. In a particular embodiment, the dynamic management system 600 of FIG. 6 or dynamic management system 700 of FIG. 7 carries out the process 800.

In an embodiment, at block 802, the process comprises creating a first action item record corresponding to a first action item of a plurality of action items of an action plan record that is responsive to a service request, the first action item record comprising a first service requirement of the first action item. In some embodiments, the service request may originate from a user or from a system monitor (e.g., such as monitoring module(s) of FIG. 3). For example, a service request may originate as ticket data recorded by system administrators responsive to a user report or a notification from a system monitor. In some embodiments, a service request exists in digital form and includes ticket data representative of information as reported by a customer describing experienced problem symptoms or a new service needed. In some embodiments, ticket data contains both pre-defined, structured fields (e.g., problem type, support person/group handling the problem, ticket creation date, failure cause, failure class fields, etc.) as well as unstructured fields (e.g., open ended text describing problems and solutions as entered by the support administrators). In some embodiments, ticket data includes a problem description supplied by a user. In some embodiments, if the ticket has been resolved, the ticket data also includes resolution data, which describes the solution to the problem described in the ticket. In some such embodiments, the resolution data can be referenced to determine a solution for another ticket that describes the same or a similar problem.

In an illustrative embodiment, the process 800 is configured to recognize that a service request has been received. In some embodiments, the process 800 detects receipt of the service request. In some embodiments, the service request includes an action plan and one or more action items that have been prepared using any known technique. An action plan may include any number of action items, and the action items may vary depending on what needs to be accomplished to resolve the corresponding service request. For the sake of clarity, Table 1 shown above is a non-limiting example of an action plan that includes four action items. Alternatively, the process 800 stores the service request until it receives an action plan with one or more action items for resolving the service request.

Responsive to receiving the service request and action plan, the process 800 creates an action item record for each action item in the action plan. The action item records each include a respective service requirement (e.g., “troubleshooting power supply system” for action item 1 in Table 1). Each action item record may include additional information, such as an action plan identifier (ID) so that the action item can easily be associated with the action plan it belongs to. Each action item may also include additional details about the actions to be taken, for example location and point-of-contact information, system details, part numbers, and service history of the system that is the subject of the service request.

Next, at block 804, the process comprises executing a querying process that searches vendor records stored in a database for candidate vendors associated with the service requirement(s) of the action item(s). In some embodiments, where the action plan includes a plurality of action items, the querying process includes searching for candidate vendors that can satisfy one or more of the plurality of service requirements. The querying process resulting in a set of candidate vendors. In some embodiments, the query results may include a mix of vendors that can satisfy varying numbers of service requirements for respective action items. For example, an action plan may include a first action item that specifies a first replacement part and a second action item that specifies a second replacement part and the query results may include a first vendor that can supply only the first replacement part (or only the second replacement part) and a second vendor that can supply both replacement parts.

In some embodiments, the process 800 generates one or more queries for information that it will use to determine an optimal response team for the corresponding service request. In some such embodiments, the process 800 uses natural language processing (NLP) to process information in an action item record, for example to identify a type of action (e.g., part replacement or troubleshooting) or a service requirement (e.g., replacement part or system expertise) of the action item.

In some embodiments, the process 800 may operate in an online mode in which it queries numerous different remote databases (e.g., remote vendor database(s) shown in FIG. 5). In some embodiments, the remote databases may include databases that are maintained by respective different service providers (or vendors) that may have various different requirements for performing a query. For example, different vendor databases will have different connection information (e.g., IP addresses or URLs), they may have data organized differently, they may have respective APIs with different API specifications, they may or may not require some form of authentication, or other differences. Additionally, or alternatively, the process 800 may operate in an offline mode in which it queries locally stored data that is periodically updated by an offline data analytics module.

In order to allow the process 800 to have visibility into vendor databases or other such sources of information, in some embodiments the process 800 maintains rules for each of the available remote databases, where the rules specify how to form a query for each respective database. In some embodiments, the process 800 also maintains rules for each available local database (i.e., where local databases refer to databases maintained by the service coordinator rather than by a third-party service provider or vendor).

In an illustrative embodiment, process 800 issues queries to one or more of the remote requirements databases. In some embodiments, each query issued to the remote requirements database is associated with a specific action item and will be constructed to search vendor records in order to identify candidate vendors that can satisfy a service requirement of the specific action item. For example, for the first action item in Table 1 above, the process 800 will issue queries to one or more remote vendor databases to identify vendors that have the ability to perform the required troubleshooting; for the second action item in Table 1, the process 800 will issue queries to one or more remote vendor databases to identify vendors that have the required replacement part available in inventory. In some embodiments, the process 800 may also retrieve information as available regarding cost and availability for each candidate vendor.

Alternatively, in some embodiments, each query issued to the remote requirements database is associated with multiple action items and will be constructed to search vendor records in order to identify candidate vendors that can satisfy service requirements of the multiple action items. For example, for action items in Table 1 above, the process 800 will issue queries to one or more remote vendor databases to identify each vendor that has the ability to timely perform the required troubleshooting and/or can timely supply the power backplane board and/or can timely supply the power wiring harness and/or has the ability to timely update the software. In some embodiments, the process 800 may also retrieve information as available regarding cost and availability for each candidate vendor.

Next, at block 806, the process comprises updating the first action item record with the first set of candidate vendors. In some embodiments, the process 800 updates the action item record with information about each candidate vendor that was found for that specific action item. Thus, for the example shown in Table 1 above, each of the four action items will have a respective list of candidate vendors. It is therefore possible that the list of candidate vendors for each of the four action items may be completely different (i.e., the lists are mutually exclusive), or may be partially or completely the same depending on the query results.

In some embodiments, once the process 800 has completed the queries for an action item, the result of the queries will include a list of one or more candidate vendors for the action item. In some such embodiments, the process 800 issues queries corresponding to each of the candidate vendors to a local reputation database. In some embodiments, the reputation database includes reputation data indicative of historical data for the candidate vendor, such as information regarding one or more past service requests assigned to a candidate vendor and how satisfied or unsatisfied the customer was with the candidate vendor's performance of the assigned action item. In some embodiments, the reputation database may include a reputation score indicative of a level of customer satisfaction for one or more past service requests handled by the candidate vendor. In some embodiments, the process 800 updates the action item record with the reputation data resulting from querying the reputation database for each candidate vendor.

Next, at block 808, the process comprises determining an optimal vendor team from among a plurality of candidate vendors of the plurality of action items, the plurality of candidate vendors including the first set of candidate vendors, based at least in part on reputation data and cost data associated with each of the plurality of candidate vendors. In some embodiments, the process 800 will generate queries for each of the action items in an action plan and will issue queries and retrieve query results for each action item in an action plan. Once all of the queries are completed for an action plan, the process 800 determines an optimal vendor team from among the one or more candidate vendors for each of one or more action items in the action plan. In some embodiments, the process 800 determines one or more optimal vendors for each action item based at least in part on the data retrieved from the queries, for example based at least in part on reputation data and/or based at least in part on cost and/or parts availability data associated with each of the plurality of candidate vendors. In some embodiments, the process 800 determines the optimal vendor team by maximizing reputation scores using the reputation data while minimizing cost using the cost data.

Next, at block 810, the process comprises updating the action plan record to include the optimal vendor team, wherein the updating of the action plan record triggers creation of a vendor team dispatch request. In some embodiments, once the process 800 has generated an optimal team, the process 800 creates a vendor team dispatch request for each vendor on the optimized team. In some embodiments, the process 800 forwards the dispatch request to each of the vendors on the optimized team. In some embodiments, the dispatch request includes information regarding the action item(s) assigned to the vendor.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method comprising:
creating a first action item record corresponding to a first action item of a plurality of action items of an action plan record that is responsive to a service request, the first action item record comprising a first service requirement of the first action item;
executing a first querying process that searches vendor records stored in a database for candidate vendors associated with the first service requirement, the first querying process resulting in a first set of candidate vendors;
updating the first action item record with the first set of candidate vendors;
determining an optimal vendor team from among a plurality of candidate vendors of the plurality of action items, the plurality of candidate vendors including the first set of candidate vendors, based at least in part on reputation data and cost data associated with each of the plurality of candidate vendors; and
updating the action plan record to include the optimal vendor team, wherein the updating of the action plan record triggers creation of a vendor team dispatch request.

2. The method of claim 1, wherein the first service requirement comprises a replacement part requirement.

3. The method of claim 2, further comprising:
retrieving part availability data from a remote database associated with a candidate vendor of the first set of candidate vendors.

4. The method of claim 3, wherein the determining of the optimal vendor team is further based at least in part on the part availability data.

5. The method of claim 2, further comprising:
creating a second action item record corresponding to a second action item of the plurality of action items of the action plan record, the second action item record comprising a second service requirement of the second action item.

6. The method of claim 5, further comprising:
executing a second querying process that searches vendor records stored in the database for candidate vendors associated with the second service requirement, the second querying process resulting in a second set of candidate vendors,
wherein the plurality of candidate vendors of the plurality of action items comprises the second set of candidate vendors.

7. The method of claim 6, further comprising:
updating the second action item record with the second set of candidate vendors.

8. The method of claim 5, wherein the second service requirement comprises a skill requirement.

9. The method of claim 8, further comprising:
retrieving a reputation dataset associated with a candidate vendor of the plurality of candidate vendors, wherein the reputation dataset is based at least in part on historical data regarding a past service request assigned to the candidate vendor,
wherein the reputation data comprises the reputation dataset.

10. The method of claim 9, wherein the reputation dataset comprises a reputation score indicative of a level of customer satisfaction for the past service request assigned to the candidate vendor.

11. The method of claim 10, wherein the determining of the optimal vendor team comprises minimizing a risk of missing a contract service level agreement for equipment to be repaired, maximizing reputation scores using the reputation data, and minimizing cost using the cost data.

12. A computer usable program product comprising one or more computer readable storage media, and program instructions collectively stored on the one or more computer readable storage media, the program instructions executable by a processor to cause the processor to perform operations comprising:
creating a first action item record corresponding to a first action item of a plurality of action items of an action plan record that is responsive to a service request, the first action item record comprising a first service requirement of the first action item;
executing a first querying process that searches vendor records stored in a database for candidate vendors associated with the first service requirement, the first querying process resulting in a first set of candidate vendors;
updating the first action item record with the first set of candidate vendors;
determining an optimal vendor team from among a plurality of candidate vendors of the plurality of action items, the plurality of candidate vendors including the first set of candidate vendors, based at least in part on reputation data and cost data associated with each of the plurality of candidate vendors; and
updating the action plan record to include the optimal vendor team, wherein the updating of the action plan record triggers creation of a vendor team dispatch request.

13. The computer usable program product of claim 12, wherein the stored program instructions are stored in a computer readable storage device in a data processing system, and wherein the stored program instructions are transferred over a network from a remote data processing system.

14. The computer usable program product of claim 12, wherein the stored program instructions are stored in a computer readable storage device in a server data processing system, and wherein the stored program instructions are downloaded over a network to a remote data processing system for use in a computer readable storage device associated with the remote data processing system, further comprising:
program instructions to meter use of the computer usable code associated with the request; and
program instructions to generate an invoice based on the metered use.

15. The computer usable program product of claim 12, wherein the first service requirement comprises a replacement part requirement.

16. The computer usable program product of claim 15, further comprising:
retrieving part availability data from a remote database associated with a candidate vendor of the first set of candidate vendors.

17. The computer usable program product of claim 16, wherein the determining of the optimal vendor team is further based at least in part on the part availability data.

18. A computer system comprising a processor and one or more computer readable storage media, and program instructions collectively stored on the one or more computer readable storage media, the program instructions executable by the processor to cause the processor to perform operations comprising:
creating a first action item record corresponding to a first action item of a plurality of action items of an action plan record that is responsive to a service request, the first action item record comprising a first service requirement of the first action item;
executing a first querying process that searches vendor records stored in a database for candidate vendors associated with the first service requirement, the first querying process resulting in a first set of candidate vendors;
updating the first action item record with the first set of candidate vendors;
determining an optimal vendor team from among a plurality of candidate vendors of the plurality of action items, the plurality of candidate vendors including the first set of candidate vendors, based at least in part on reputation data and cost data associated with each of the plurality of candidate vendors; and
updating the action plan record to include the optimal vendor team, wherein the updating of the action plan record triggers creation of a vendor team dispatch request.

19. The computer system of claim 18, wherein the first service requirement comprises a replacement part requirement.

20. The computer system of claim 19, further comprising:
retrieving part availability data from a remote database associated with a candidate vendor of the first set of candidate vendors.
